(19) United States
(12) Patent Application Publication
(10) Pub. No.: US 2013/0162158 A1
(43) Pub. Date: Jun. 27, 2013

(54) Circuit Assembly and Method for Operating at Least one LED

(71) Applicant: Thomas Pollischansky, Munchen (DE)

(72) Inventor: Thomas Pollischansky, Munchen (DE)

(21) Appl. No.: 13/820,101

(22) PCT Filed: Jul. 28, 2011
(86) PCT No.: PCT/EP11/62970

§ 371 Date: Feb. 28, 2013

(30) Foreign Application Priority Data
Aug. 31, 2010 (DE) 10 2010 039 973.6

(51) Int. Cl. H05B 37/02

(52) U.S. Cl. CPC H05B 37/02
USPC 315/201

(57) ABSTRACT

Operating at least one LED on a circuit assembly having an input with first (E1) and second input terminals for coupling to an alternating supply voltage modified by a phase dimmer (12) for setting a dimming angle. Rectifier (14) has an input and an output, with its input being coupled to the circuit assembly's input. Signal (UC1) at the rectifier output is compared with a comparison value. PWM signal (S0) has a first frequency and the dimming angle is correlated with its pulse width. PWM signal having the first frequency (f1) is converted into a PWM signal (S3) that has a second frequency, and the dimming angle is correlated with its pulse width. Controllable current source (22), which is coupled on the input side to the rectifier output, is controlled with PWM signal (S3), with the at least one LED being coupled to the output of the controllable current source.

### TECHNICAL FIELD

The present invention relates to a circuit assembly for operating at least one LED, said assembly having an input that has a first and second input terminal for coupling to an alternating supply voltage modified by a phase dimmer for setting a dimming angle, and having a rectifier that has an input and an output, with the rectifier's input being coupled to the circuit assembly's input. It relates further to a corresponding method for operating at least one LED. The terms “dimming angle” and “phase angle” are employed synonymously in the explanations that follow.

### PRIOR ART

The present invention relates to a subject matter known by the term “retrofitting”. The aim therein is to replace incandescent or halogen lamps with lamps or luminaires having LEDs. The reason is that LEDs are more efficient and have a longer service life. What is of particular interest in this connection is for the aforementioned replacement of incandescent or halogen lamps with LEDs to be performed such that, on the one hand, existing installations can continue being used with as few modifications as possible and, on the other hand, the characteristics, for example color point, dimming possibility, and suchlike, associated with the incandescent or halogen lamps originally employed can continue being made available to the user.

The problem associated with the present invention is particularly that of controlling the LEDs for dimming purposes using the same phase dimmer employed for the previously installed incandescent or halogen lamps. What in other words is desired is for the at least one LED's brightness to be able to be controlled in particular by a phase-control dimmer. Phase-control dimmers are actually thyristor or triac controllers for adjusting the brightness of incandescent or halogen lamps. Incandescent and halogen lamps have an ohmic or inductive load characteristic so are dimmed by means of phase-angle controlling. Electronic transformers in low-voltage halogen systems have a capacitive load characteristic and have to be controlled using reverse phase-control dimmers. A dimmer can be operated in different ways. Apart from by means of the known rotary button, modern devices can today also be controlled using pushbuttons. A brief push will turn the dimmer on or off, for example, while a longer keying pulse will cause the brightness to change. Controlling via a digital bus such as DMX, for example, is also known. That is employed in stage lighting, for instance.

It is known from the prior art how to reduce the dc current for driving the at least one LED in proportion to the dimming angle. That method is employed in, for example, the ICL8001G chip from the company Infineon. What, though, is disadvantageous about that method is that the color of the light emitted by the at least one LED also changes when the dimming angle is changed.

### DESCRIPTION OF THE INVENTION

The object of the present invention is therefore to further develop a circuit assembly as cited in the introduction or, as the case may be, a method as cited in the introduction in such a way as to enable the at least one LED to be dimmed by means of a phase dimmer without changing the color of the light emitted by the at least one LED.

Said object is achieved by means of a circuit assembly having the features of claim 1 and by means of a method having the features of claim 11.

The present invention is based on the knowledge that the above will basically be made possible if the at least one LED is controlled by means of a PWM signal in the case of which the pulse width corresponds to the dimming angle by means of which the alternating supply voltage was modified by the phase dimmer. Because the amplitude of the PWM signal is constant independently of the dimming angle, the color of the light emitted by the at least one LED will—in contrast to the prior art—not change under the influence of differently set dimming angles. Rather it is the case that the dimming angle is reflected in the PWM signal's pulse width. An inventive circuit assembly therefore includes a controllable current source that is coupled on the input side to the rectifier output, with the controllable current source being designed to provide at its output a PWM signal to the at least one LED, with the controllable current source including a control input for controlling at least the pulse width of the PWM signal. An inventive circuit assembly further includes a comparison device having a first input coupled to the rectifier's output, a second input coupled to a comparison-value-provisioning device, and an output, with the comparison device being designed to provide at its output a

PWM signal that has a first frequency and in the case of which the dimming angle is correlated with the pulse width. Finally, an inventive circuit assembly includes a control device having an input and an output, with the control device's input being coupled to the comparison device's output, with the control device's output being coupled to the controllable current source's control input, with the control device being designed for converting the signal at the comparison device's output into a PWM signal that has a second frequency and in the case of which the dimming angle is correlated with the pulse width, and for making it available at its output.

A rectangular signal having twice the frequency of the alternating supply voltage is in the case of the present invention accordingly generated by the comparison device from the voltage after the rectifier. Twice the frequency of the alternating supply voltage will accordingly be 100 or 120 Hz depending on the public power supply. The dimming angle is therein reflected in the pulse width. A PWM signal for pulse-width modulating the output current by means of which the at least one LED is operated is made available by the control device to the controllable current source. The second frequency is at least 200 Hz in order to avoid optical effects. The at least one LED can therefore be provided by means of an inventive circuit assembly with a constant light color over a wide dimming range. That is made possible in the present instance in particular without the need for complex and so costly A/D conversion.

In a preferred development, a dependency function for transforming a pulse width of the signal at the comparison device's output into a pulse width of the signal at the control device's output has been filed in the control device. Said dependency function is preferably logarithmic, with its being rendered in particular in the form of a characteristic curve, a formula, or a look-up table. A characteristic curve of such kind will make it possible on the one hand to perform matching to the sensitivity of the human eye and, on the other, to take into account that brightness in the case of an incandescent lamp is likewise logarithmically linked to the dimming angle. Preset values of the phase dimmer will therefore result in light emissions whose relationship corresponds to that of light emissions that have resulted for analogous phase-dimmer settings and in operating incandescent or halogen lamps.

In a multiplicity of operating devices for LEDs, galvanic insulating is required between the public-supply input and the output of the operating device in order to ensure shock-hazard protection conforming to the SELV standard for the operating device's output. An optocoupler is coupled between the comparison device's output and the control device's input in that especially preferred embodiment variant. Whereas in the case of the cited ICL8001G chip, with potential isolating on the primary side the current through the transformer is measured and the setpoint value for the output power is matched to the dimming angle, which has the disadvantage that the output current is dependent on the number of LEDs connected in series at the circuit assembly's output, the present invention employs an opto-coupler for transmitting the PWM signal at the comparison device's output. Because the first frequency is at most 120 Hz and the delay is canceled out during switching-on and switching-off, it is possible to use a more economical optocoupler having a long delay. An optocoupler having an insulation strength of at least 5,000 V can be favored for insulated operating devices.

That measure allows the output power on the secondary side to be matched to the dimming angle on the primary side. It is in the present case in particular possible to evaluate the dimming angle on the secondary side and thus more precisely regulate the current requiring to be provided to the at least one LED.

The control device preferably includes a filtering device that is designed for determining a momentary frequency of the PWM signal by means particularly of two successive rising edges of the PWM signal at the comparison device's output. That embodiment variant relates to the problem that owing to the lesser power needed to produce the same luminosity in a luminaire when LEDs are employed instead of incandescent or halogen lamps, the holding current of the phase dimmer's triac may not always suffice and it will keep triggering. The result is undesired flickering of the LED lamp or, as the case may be, LED luminaire. In the prior art it is known in this connection how to employ a dropping resistor so that the holding current will be sufficiently high to prevent extinguishing of the triac. That approach can be applied at best to low-power LED retrofits because excessive losses would otherwise be caused by the dropping resistor.

The phase dimmer's triac can be triggered for determining the phase angle by what is termed a bleeder resistor. With that approach, a dropping resistor is provided upstream of the electronic ballast with a switch furthermore being provided that is coupled in parallel to a serial arrangement of the rectifier output and a serial resistor connected in series. The ballast's dropping resistor and its internal resistor can be connected in parallel by the switch. More current will flow into the triac owing to the lower overall resistance that can be achieved thereby so that the triac's holding or, as the case may be, dimming current can be attained. However, that measure is not sufficient in the case of luminaires having a low input power. There, too, extinguishing of the triac can occur again because a sufficient holding current is not attained.

To avoid flickering due to extinguishing and retriggering of the triac in the phase dimmer, the dimming angle is inventively preferably evaluated only for the power-supply half waves in the case of which no extinguishing and retriggering of the triac will occur. The frequency of the PWM signal is for that purpose determined at the control device's input.

If that frequency, which is to say the one referred to in the foregoing as the “first frequency”, corresponds to twice the frequency of the alternating supply voltage, then it can be assumed that no extinguishing of the phase dimmer's triac has occurred. That is because extinguishing and retriggering of the triac will result in an at least 10% higher frequency. The signal's frequency is determined at the control device's input by evaluating two successive rising edges. The control device is therefore preferably designed to evaluate the signal at its input only if the filtering device determines that the momentary frequency corresponds to twice the frequency of the alternating supply voltage. Flickering even when extinguishing of the phase dimmer's triac occurs will be reliably prevented by that preferred embodiment variant.

The control device is preferably further designed not to change the control signal momentarily provided at its output if the filtering device determines that the momentary frequency of the PWM signal is greater than, twice the frequency of the alternating supply voltage. Thus if there is an indication of possible extinguishing of the phase dimmer's triac, the current PWM signal will not be evaluated but, instead, the controllable current source will continue being controlled by means of the momentary control signal. Undesired variations in brightness that would have been caused by extinguishing of the triac can be reliably prevented thereby.

The control device particularly advantageously includes a time-measuring device for determining the pulse width of the signal at its input. No additional costs or effort will be incurred when a microcontroller is used to realize an inventive control device since most microcontrollers already include suitable time-measuring devices of such kind. As already mentioned, the second frequency is at least 200 Hz in order to obviate optical effects perceptible by the human eye.

The serial arrangement of a device for power-factor correcting, in particular a boost converter, an inverter, and a transformer, is particularly preferably coupled between the rectifier output and controllable current source.

Further preferred embodiment variants will emerge from the sub-claims.

The preferred embodiment variants presented with reference to the inventive circuit assembly and their advantages apply analogously, where practicable, to the inventive method.

### SHORT DESCRIPTION OF THE DRAWING(S)

An exemplary embodiment of an inventive circuit assembly is now described in more detail below with reference to the attached drawings:

FIG. 1 is a schematic of an exemplary embodiment of an inventive circuit assembly; and

FIG. 2 is a schematic of the time curve of different signals of the exemplary embodiment shown in FIG. 1.

### PREFERRED EMBODIMENT OF THE INVENTION

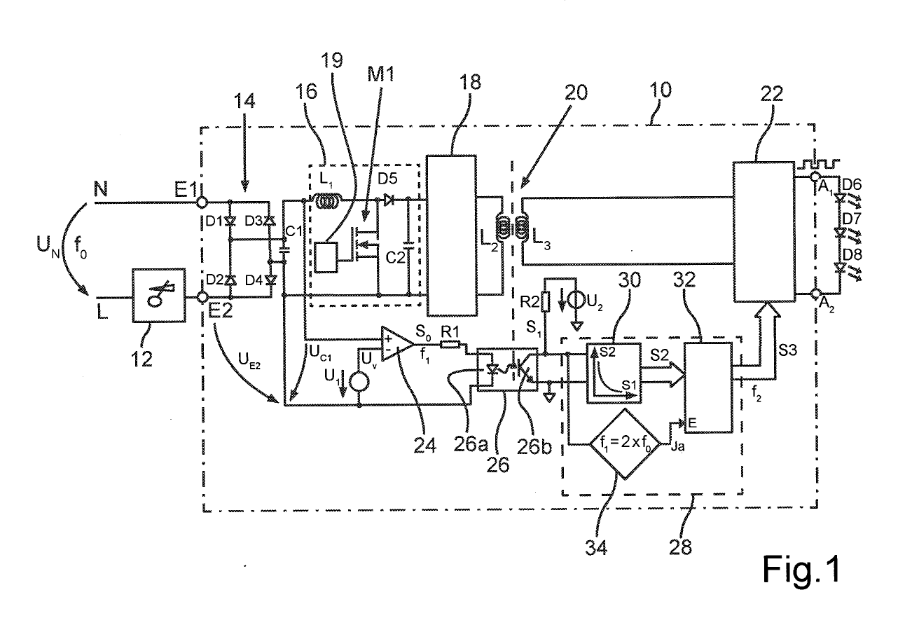

FIG. 1 is a schematic of an exemplary embodiment of an inventive circuit assembly 10. It has an input that has a first E1 and a second input terminal E2. Input terminal E1 is coupled to a first phase N of a public power-supply voltage U_{N} while input E2 is coupled via a phase dimmer 12, which can be embodied in particular as a phase-control dimmer, to a phase L of public power-supply voltage U_{N}. Public power-supply voltage U_{N} can have in particular a frequency f₀ of 50 Hz or 60 Hz. A dimming angle is set by phase dimmer 12, which means the length of time is established during which a predefinable range within a cycle of public power-supply voltage U_{N} is kept at 0 V by means of phase controlling or reverse phase controlling. If a cycle duration is 360°, then dimming angle W_{D} can assume a value in the 0°-to-180° range. Phase dimmer 12 can have an interface via which the dimming angle can be set manually or electronically.

The input of a rectifier 14 that includes diodes D1, D2, D3, D4 is coupled between input terminals E1, E2. A smoothing capacitor C1 is coupled between the output terminals of rectifier 14. Coupled to smoothing capacitor C1 in a first branch is the serial arrangement of a device 16 for power-factor correcting, a storage capacitor C2, an inverter 18, a transformer 20, and a controllable current source 22.

The voltage between input terminal E2 and low-side terminal of smoothing capacitor C1 is identified with U_{E2} and the voltage above the storage capacitor with U_{C1}.

Device 16 for power-factor correcting can be embodied in particular as a boost converter and include an electronic switch M1, an inductor L1, and a diode D5. Electronic switch M1 is controlled via a PFC control IC 19, for example a type L6562 or TDA4862. Storage capacitor C2 is embodied in particular as an electrolytic capacitor and ensures the circuit assembly's power supply during the blocking phase of phase dimmer 12. Inverter 18 can be embodied in particular as a half-bridge arrangement. Transformer 20 includes a primary inductor L2 and a secondary inductor L3. Controllable current source 22 is coupled on its output side to the output of circuit assembly 10, which output includes a first output terminal A1 and a second output terminal A2, with the serial arrangement of a plurality of LEDs D6, D7, D8 being coupled between output terminals A1, A2.

A second branch is furthermore coupled to the output of smoothing capacitor C1; the positive input of a comparison device 24 is therein coupled to the high-side terminal of smoothing capacitor C1 and the negative input is coupled to a voltage source U1 which makes a comparison value Uᵥ available to comparison device 24. A PWM signal S₀ that has a frequency f₁ and usually—other embodiments are described further below—corresponds to twice the public power-supply frequency of public power-supply voltage U_{N} accordingly appears at the output of comparison device 24. The pulse width of said signal S₀ is correlated with dimming angle W_{D}.

The output signal of comparison device 24 is fed via an ohmic resistor R1 to an optocoupler 26 that includes an LED 26a and a phototransistor 26b. A voltage source U2 that is coupled via an ohmic resistor R2 to the collector of phototransistor 26b serves as a power supply for optocoupler 26. Present at the output of optocoupler 26 is a signal S1 which is applied to the input of a control device 28. Said device has an imaging device 30 by means of which signal S1 is transformed via logarithmic imaging into a signal S2. Signal S1 and signal S2 are each a PWM signal, with the pulse width of signal S₁ having been modified by imaging device 30 in keeping with a logarithmic dependency function.

Signal S2 is fed to a storage device 32 serving to convert signal S2 having frequency f₁ into a signal S3 having frequency f₂. Frequency f₂ is preferably at least 200 Hz in order to preclude optical artifacts perceptible by the human eye. Signal S3 is coupled to the control input of controllable current source 22, as a result of which controllable current source 22 feeds out at its output A1, A2 a PWM signal that has frequency f₂ and whose pulse width corresponds to that of signal S3.

Control device 28 further includes a filtering device 34 designed for ascertaining a momentary frequency fₘ of PWM signal S1. That is done in particular by means of two successive rising edges of PWM signal S1. If filtering device 34 determines that momentary frequency fₘ corresponds to twice frequency f₀ of alternating supply voltage U_{N}, it will release storage device 32, thereby enabling signal S3 to be made available to controllable current source 22 as a function of signal S2. If, conversely, filtering device 34 determines that frequency f₁ of signal S1 is greater, in particular more than 10% greater than twice frequency f₀ of the alternating supply voltage, then it will assume that extinguishing of the triac of phase dimmer 12 occurred within the last cycle of signal S1 and that momentary signal S1 therefore does not correspond to the actual dimming wish. Rather it is the case that signal S1 was impermissibly modified through extinguishing and retriggering of the triac of phase dimmer 12. Filtering device 34 will thereupon control storage device 32 such that it will not evaluate current signal S2 but instead continue controlling controllable current source 22 using momentary signal S3 until, during a succeeding evaluation, filtering device 34 determines the presence of a signal S1 that can be evaluated and has not been adversely affected by extinguishing and retriggering of the triac of phase dimmer 12.

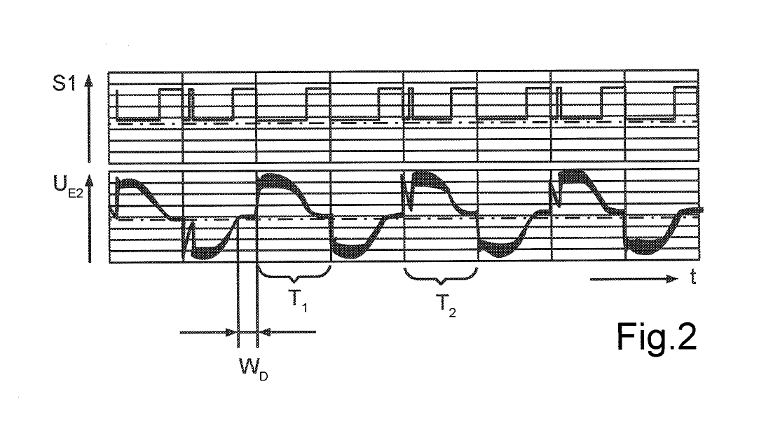

FIG. 2 shows the time curve of signals S1 (top) and U_{E2} (bottom) of the exemplary embodiment of an inventive circuit assembly 10 shown in FIG. 1. A unit of the time axis corresponds to 10 ms. Frequency f₀ of alternating supply voltage U_{N} is 50 Hz. Dimming angle W_{D} is predominantly 30°. As can clearly be seen, no extinguishing of the triac occurs during the period T₁; frequency f₁ is 100 Hz. Filtering device 34 releases to signal S3 the converting of signal S2. During period T₂, conversely, frequency f₁ of signal S1 is above 100 Hz. That is an indication that extinguishing of the triac of phase dimmer 12 has occurred, which is confirmed by the corresponding time curve of voltage U_{E2}. Extinguishing gives rise to a narrow peak in signal S1, the result of which is that the filtering device determines a frequency f₁ that is greater than twice the frequency f₀ of alternating supply voltage U_{N}. Filtering device 34 will therefore control storage device 32 such that it will not evaluate current signal S2 but will instead, with reference to FIG. 2, provide for controllable current source 22 to be controlled by means of a signal S3 that was evaluated on the basis of the curve of signal S1 before period T₂.

1. A circuit assembly for operating at least one LED comprising:
an input that has a first and a second input terminal for coupling to an alternating supply voltage modified by a phase dimmer for setting a dimming angle;
a rectifier having an input and an output, with the input of the rectifier being coupled to the circuit assembly's input;
a controllable current source that is coupled on its input side to the rectifier output, with the controllable current source being adapted to provide at its output a PWM signal to the at least one LED, with the controllable current source including a control input for controlling at least the pulse width of the PWM signal;
a comparison device having a first input coupled to the rectifier's output, a second input coupled to a comparison-value-provisioning device, and an output, with the comparison device being adapted to provide at its output a PWM signal that has a first frequency and in the case of which the dimming angle is correlated with the pulse width; and a control device having an input and an output, with the input of the control device being coupled to the output of the comparison device, with the output of the control device being coupled to the control input of the controllable current source, with the control device being adapted for converting the signal at the output of the comparison device into a PWM signal that has a second frequency and in the case of which the dimming angle is correlated with the pulse width, and for making it available at its output.

2. The circuit assembly as claimed in claim 1, wherein a dependency function for transforming a pulse width of the signal at the output of the comparison device into a pulse width of the signal at the output of the control device has been stored in the control device.

3. The circuit assembly as claimed in claim 2, wherein the dependency function is logarithmic, with its being rendered in particular as a characteristic curve, a formula, or a look-up table.

4. The circuit assembly as claimed in claim 1, wherein an optocoupler is coupled between the output of the comparison device and the input of the control device.

5. The circuit assembly as claimed in claim 1, wherein the control device includes a filtering device, with the filtering device adapted for determining a momentary frequency of the PWM signal with two successive rising edges of the PWM signal at the output of the comparison device.

6. The circuit assembly as claimed in claim 5, wherein the control device is adapted to evaluate the signal at its input only if the filtering device determines that the momentary frequency corresponds to twice the frequency of the alternating supply voltage.

7. The circuit assembly as claimed in claim 5, wherein the control device is adapted not to change the control signal momentarily provided at its output if the filtering device determines that the momentary frequency of the PWM signal is greater than twice the frequency of the alternating supply voltage.

8. The circuit assembly as claimed in claim 1, wherein the control device includes a time-measuring device for determining the pulse width of the signal at its input.

9. The circuit assembly as claimed in claim 1, wherein the second frequency is at least 200 Hz.

10. The circuit assembly as claimed in claim 1, wherein the serial arrangement of a device for power-factor correcting, in particular a boost converter, a storage capacitor, an inverter, and a transformer, is coupled between the rectifier output and controllable current source.

11. A method for operating at least one LED on a circuit assembly having an input that has a first and a second input terminal for coupling to an alternating supply voltage modified by a phase dimmer for setting a dimming angle, and having a rectifier that has an input and an output, with the input of the rectifier being coupled to the circuit assembly's input;
wherein the method comprises the steps of:
comparing the signal at the rectifier output with a comparison value and making a PWM signal available that has a first frequency and in the case of which the dimming angle is correlated with the pulse width;
converting the PWM signal having the first frequency into a PWM signal that has a second frequency and in the case of which the dimming angle is correlated with the pulse width; and
controlling a controllable current source, which is coupled on the input side to the rectifier output, with the PWM signal having the second frequency, with the at least one LED being coupled to the output of the controllable current source.
